(19) United States
(12) Patent Application Publication
(10) Pub. No.: US 2007/0005710 A1
(43) Pub. Date: Jan. 4, 2007

(54) Message communication channel

(75) Inventors: Bryan T. Starbuck, Redmond, WA (US); Jeffrey J. Wall, Sammamish, WA (US); John S. Strauch, Redmond, WA (US); Ojiakonobi Udezue, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/170,721

(22) Filed: Jun. 29, 2005

(51) Int. Cl. G06F 15/16

(52) U.S. Cl. 709/206

(57) ABSTRACT

A message communication channel is described. In an implementation, a method includes determining whether an intended recipient of a message is included in a list; and when the intended recipient is included, configuring the message to indicate that a particular image which represents a sender of the message is specified for output in conjunction with messages from the sender by the intended recipient.

### BACKGROUND

Message communication has provided a wide range of increased functionality to users of computing devices, such as personal computers, wireless phones, and so on. For example, users may communicate, one to another, through the use of email, i.e., electronic mail. Email employs standards and conventions for addressing and routing such that the email may be delivered across a network, such as the Internet, utilizing a plurality of devices. In this way, emails may be transferred within a company over an intranet, across the world using the Internet, and so on.

The use of email has provided a number of advantages to the user. For example, even though email may be communicated almost instantaneously, email can be dealt with according to the recipient's own schedule, such as when the email is received to provide an immediate response, at a later time when the user has sufficient resources to answer the message, and so on. Additionally, email may allow the user to prioritize messages, such as when to respond to one or more particular emails that were received by the user. Because of these and other advantages, the prevalence of email has continued to expand such that email is now considered an indispensable part of everyday life, both at home and during a typical business day.

In another example, users may communicate, one to another, through the use of instant messaging. For instance, when two users are online at the same time, instant messages may be exchanged in real time between the two users. In this way, the instant messages may be utilized to support a text conversation between the two users in a manner that mimics how the two users would participate in a typical spoken conversation. A variety of other messaging techniques may also be employed in a given day by a user.

As the prevalence of message communication continues to increase, the desire of users to communicate using messages in a “richer” manner also continues to increase. For example, the users may desire an output of audio and video in conjunction with the message. However, such output may be complicated by different capabilities of computing devices which communicate messages, such as devices having different versions of software, display capabilities, and so on. Further, as the prevalence of message communication continues to increase, so do attacks by malicious parties which seek to disrupt the communication of the messages.

### SUMMARY

A message communication channel is described which may provide techniques to communicate supplemental data between users, such as user tiles, contact information, certificates, and so on. For example, an asynchronous technique may be employed in which supplemental “payload” (e.g., a user tile) is added to messages having a payload specified for communication to a recipient, such as text and attachments. An email message composed by a first user, for instance, may include text specified by the first user to be communicated to a second user. The email message may also include an indication that a user tile is available for output in conjunction with messages from the first user. The second user, upon receipt of the message, may indicate that user tile functionality is supported and request the user tile in a subsequent message sent to the first user. This indication may be provided in a message that includes a payload specified by the second user that is not sent specifically to obtain the user tile, e.g., the message may include a response to the user. Upon receipt of this message by the first user, the user tile may be provided in another message for communication to the second user. Thus, a “message communication channel” may be provided that leverages messages which are to be communicated between the users.

### BRIEF DESCRIPTION OF THE DRAWINGS

FIG. 1 is an illustration of an environment operable for communication of messages, such as emails, instant messages, and so on, across a network.

FIG. 2 is an illustration of a system in an exemplary implementation showing a plurality of clients and a communication service of FIG. 1 in greater detail.

FIG. 3 is a flow diagram depicting a procedure in an exemplary implementation in which messages are communicated to provide a message communication channel between clients for communication of supplemental data.

FIG. 4 is a flow diagram depicting a procedure in an exemplary implementation in which an image is provided for concurrent display with a message configured as an email.

FIG. 5 is an illustration of a user interface in which an image is displayed in conjunction with a message, the image representing a sender of the message as specified by the sender of the message.

FIG. 6 is an illustration of a user interface in which an image is displayed in conjunction with a message selected from the user interface of FIG. 5 is displayed in conjunction with a payload of the message that was specified by the sender of the message.

FIG. 7 is a flow diagram depicting a procedure in an exemplary implementation in which an image is indicated for receipt by a recipient when the recipient is included in a list and the sender is verified using the message communication channel.

FIG. 8 is an illustration of a user interface in an exemplary implementation in which an email user interface of FIG. 5 is shown as including an indication that a corresponding sender of a message has been validated.

FIG. 9 is a flow diagram depicting a procedure in an exemplary implementation in which communication of supplemental payload including contact information via the message communication channel of FIG. 1 is described.

FIG. 10 is a flow diagram depicting a procedure in an exemplary implementation in which presence of an intended recipient in an address book is utilized to determine whether contact information of the sender is to be provided to the intended recipient.

The same reference numbers are utilized in instances in the discussion to reference like structures and components.

### DETAILED DESCRIPTION

Overview

Message communication techniques are described which may utilize a message communication channel. Messages may be utilized to provide a wide variety of functionality. For example, today users are exposed daily to a large quantity of email. Because of this large quantity, it may be difficult for the user to differentiate between the different emails. One technique that may be utilized to provide this differentiation is a “friends” list. For instance, a toolbar button may be provided that lets a user mark emails (and more particularly a sender of the email) as a “friend”. The toolbar button, when selected, may add the “FROM:” line from the email to the friends list. Subsequent emails which are communicated from that sender may then be marked as being sent from a “friend” and therefore focus the user's attention to these emails. This marking may be performed in a variety of ways.

A user, for example, may specify a user tile to be utilized for representing the user in conjunction with an output of an email message. For instance, the user tile may be configured as a picture of the user, the user's favorite actor, cartoon character, and so on. The user tile may be provided to a recipient of an email message from the user such that the recipient may view the user tile and readily differentiate emails from that user from other emails.

A variety of techniques may be utilized to communicate supplemental data (e.g., the user tile) between a sender of the message and the recipient. For instance, an asynchronous technique may be employed in which supplemental “payload” (e.g., the user tile) is added to messages having a payload specified for communication to the recipient. For example, an email message composed by a user may have the user tile appended to the email message for communication to the recipient. This communication may be utilized to provide a “message communication channel” between the sender and recipient for communication of user specified payloads as well as supplemental payloads, further discussion of which may be found in relation to the following figures.

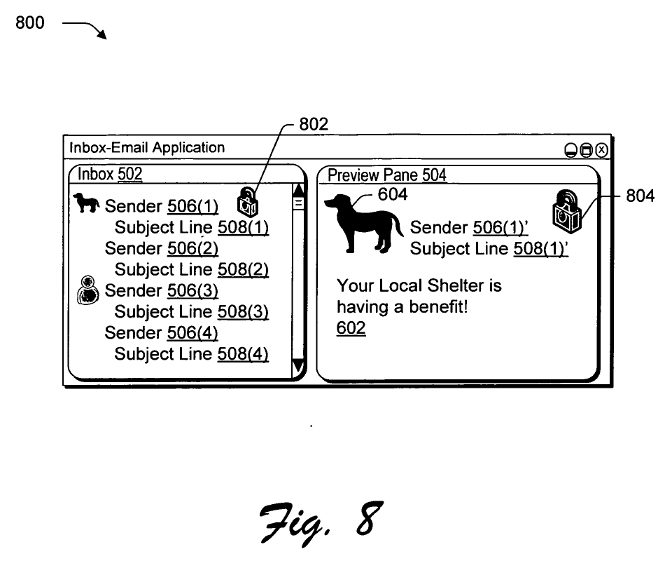

Although use of the message communication channel has been described for communication of user tiles, the message communication channel may be utilized to communication a variety of supplemental data. For example, the message communication channel may be utilized to communicate certificates to verify the identity of the sender of the message. Additionally, the verified identity of the sender may be utilized to output an indication (e.g., a lock) which describes that the sender's identity has been verified. In another example, the message communication channel may be utilized to communicate contact information between users, update contact information of the user on another user's computer, and so on. Further discussion of use of the message communication channel for communication of supplemental payloads may be found in relation to FIGS. 7-10.

In the following discussion, an exemplary environment is first described which is configured for communication of messages and may employ the message communication channel. Exemplary procedures are then described which may be implemented in the exemplary environment, as well as in other environments.

Exemplary Environment

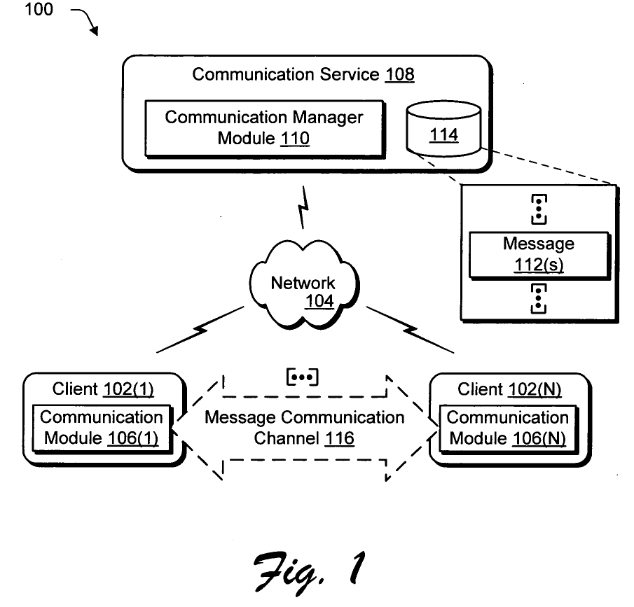

FIG. 1 is an illustration of an environment 100 operable for communication of messages across a network. The environment 100 is illustrated as including a plurality of clients 102(1), . . . , 102(N) that are communicatively coupled, one to another, over a network 104. The plurality of clients 102(1)-102(N) may be configured in a variety of ways. For example, one or more of the clients 102(1)-102(N) may be configured as a computer that is capable of communicating over the network 104, such as a desktop computer, a mobile station, a game console, an entertainment appliance, a set-top box communicatively coupled to a display device, a wireless phone, and so forth. The clients 102(1)-102(N) may range from full resource devices with substantial memory and processor resources (e.g., personal computers, television recorders equipped with hard disk) to low-resource devices with limited memory and/or processing resources (e.g., traditional set-top boxes). In the following discussion, the clients 102(1)-102(N) may also relate to a person and/or entity that operate the client. In other words, the clients 102(1)-102(N) may describe a logical client that includes a user and/or a machine.

Additionally, although the network 104 is illustrated as the Internet, the network may assume a wide variety of configurations. For example, the network 104 may include a wide area network (WAN), a local area network (LAN), a wireless network, a public telephone network, an intranet, and so on. Further, although a single network 104 is shown, the network 104 may be configured to include multiple networks. For instance, clients 102(1), 102(N) may be communicatively coupled via a peer-to-peer network to communicate, one to another. Each of the clients 102(1), 102(N) may also be communicatively coupled to a communication service 108 over the Internet. A variety of other examples are also contemplated.

Each of the plurality of clients 102(1)-102(N) is illustrated as including a respective one of a plurality of communication modules 108(1), . . . , 108(N). In the illustrated implementation, each of the plurality of communication modules 108(1)-108(N) is executable on a respective one of the plurality of clients 102(1)-102(N) to send and receive messages. For example, one or more of the communication modules 108(1)-108(N) may be configured to send and receive email. As previously described, email employs standards and conventions for addressing and routing such that the email may be delivered across the network 104 utilizing a plurality of devices, such as routers, other computing devices (e.g., email servers), and so on. In this way, emails may be transferred within a company over an intranet, across the world using the Internet, and so on. An email, for instance, may include a header and a user-specified payload, such as text and attachments, e.g., documents, computer-executable files, and so on. The header contains technical information about the source and oftentimes may describe the route the message took from sender to recipient.

In another example, one or more of the communication modules 108(1)-108(N) may be configured to send and receive instant messages. Instant messaging provides a mechanism such that each of the clients 102(1)-102(N), when participating in an instant messaging session, may send text messages to each other. The instant messages are typically communicated in real time, although delayed delivery may also be utilized, such as by logging the text messages when one of the clients 102(1)-102(N) is unavailable, e.g., offline. Thus, instant messaging may be though of as a combination of e-mail and Internet chat in that instant messaging supports message exchange and is designed for two-way live chats. Therefore, instant messaging may be utilized for synchronous communication. For instance, like a voice telephone call, an instant messaging session may be performed in real-time such that each user may respond to each other user as the instant messages are received. Although messages configured as instant messages and emails have been described, messages may be configured in a wide variety of other ways, such as voicemail.

In an implementation, the communication modules 106(1)-106(N) communicate with each other through use of a communication service 108. The communication service 108 is illustrated as including a communication manager module 110 (hereinafter “manager module”) which is executable to route messages between the communication modules 106(1)-106(N). For instance, client 102(1) may cause the communication module 106(1) to form an instant message for communication to client 102(N). The communication module 106(1) is executed to communicate the instant message to the communication service 108, which then executes the manager module 110 to route the instant message to the client 102(N) over the network 104. The client 102(N) receives the instant message and executes the respective communication module 106(N) to display the instant message to a respective user. In another instance, when the clients 102(1), 102(N) are communicatively coupled directly, one to another (e.g., via a peer-to-peer network), the instant messages are communicated without utilizing the communication service 108.

In another example, the communication service 108 may be configured to store and route email, such as through configuration as an email provider. For instance, like the previous example, client 102(1) may execute the communication module 106(1) to form an email for communication to client 102(N). The communication module 106(1) communicates the email to the communication service 108, which is then stored as one of a plurality of messages 112(s), where “s” can be any integer from one to “S”, which are stored in storage 114. Client 102(N), to retrieve the email, “logs on” to the communication service 108 (e.g., by providing user identification and password) and retrieves emails from a respective user's account. In this way, a user may retrieve corresponding emails from one or more of the plurality of clients 102(1)-102(N) that are communicatively coupled to the communication service 108 over the network 104. Although messages configured as emails and instant messages have been described, a variety of textual and non-textual messages (e.g., graphical messages, audio messages, and so on) may be communicated via the environment 100 without departing from the sprit and scope thereof.

As previously described, the clients 102(1)-102(N) may desire a “rich” communication experience from the described environment 100. To provide this experience, the environment 100 may be configured to provide a message communication channel 116. The message communication channel 116 is configured to provide supplemental data communication between the plurality of clients 102(1)-102(N) and may be provided by leveraging messaging techniques employed by the communication modules 106(1)-106(N). For example, the message communication channel 116 is illustrated in phantom (through use of a dashed outline) to indicate communication between the communication modules 106(1)-106(N) that is provided through use of the network 104. This communication may be provided in a variety of ways depending on the communication modules 106(1)-106(N). For example, when the communication modules 106(1)-106(N) are configured to provide email, email messages may be formed for communication of data which is to supplement messages sent by the communication modules, such as user tiles, certificates, contact information, and other supplemental data as previously described. Thus, the messages, when supplemented, may provide additional functionality to the communication experience.

The supplemental data may be communicated via the message communication channel 116 in a variety of ways. For example, synchronous communication may be utilized in which messages are communicated between the clients 102(1)-102(N) without users of the clients 102(1)-102(N) being aware that the messages are being communicated.

In another example, asynchronous communication may be used such that the additional data is appended to messages that are being sent for other reasons. For instance, client 102(1) may communicate with client 102(N) utilizing a plurality of messages. A first message may be sent to client 102(N) indicating that the client 102(1) supports user-tile functionality. When the client 102(N) responds to the first message (e.g., responds to a text query specified by a user of client 102(1)), the communication module may configure the response to indicate that the client 102(N) also supports user-tile functionality and request the user tile from the client 102(N). The client 102(1) may then configure the next message that is communicated to the client 102(N) to include the user tile. Although a user tile has been described, a variety of other data may also be communicated utilizing the data channel as previously described, further discussion of which may be found in the following figures.

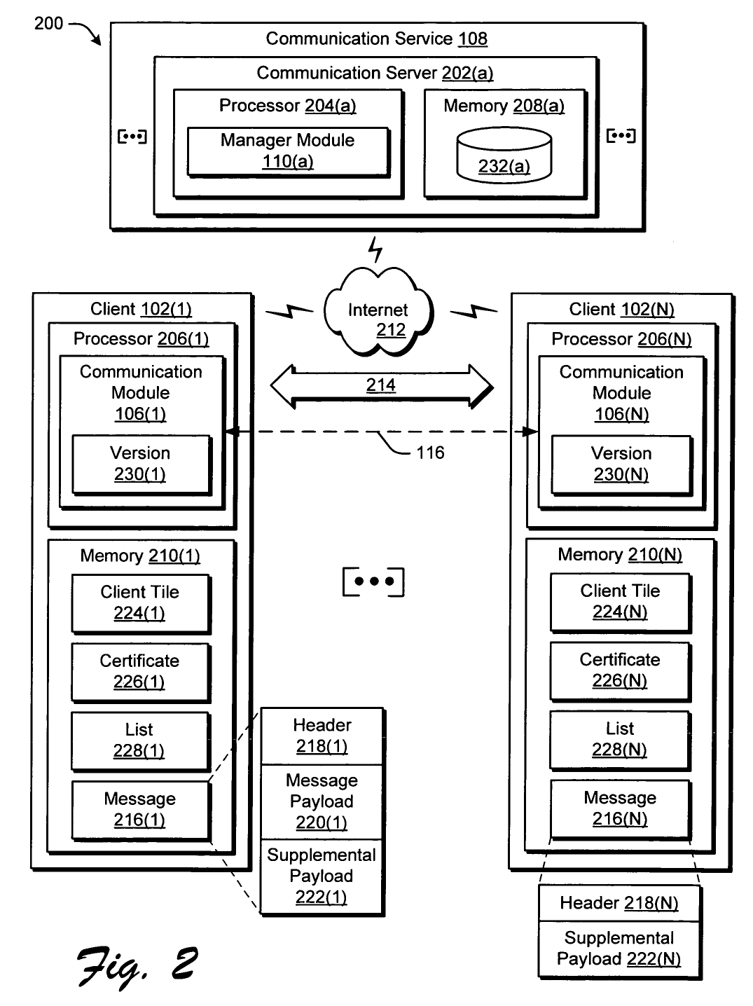

Generally, any of the functions described herein can be implemented using software, firmware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., CPU or CPUs). The program code can be stored in one or more computer readable memory devices, further description of which may be found in relation to FIG. 2. The features of the message communication channel strategies described below are platform-independent, meaning that the strategies may be implemented on a variety of commercial computing platforms having a variety of processors.

FIG. 2 is an illustration of a system 200 in an exemplary implementation showing the plurality of clients 102(n) and the communication service 108 of FIG. 1 in greater detail. The communication service 108 is illustrated as being implemented by a plurality of communication servers 202(a), where “a” can be any integer from one to “A”. Accordingly, the manager module of FIG. 1 is illustrated as manager module 110(a) to indicate that each of the plurality of communication servers 202(a) may utilize a respective manager module 110(a). Additionally, each of the plurality of clients 102(1)-102(N) is illustrated as a client device. Accordingly, the communication servers 202(a) and the clients 102(1)-102(N) are illustrated as including a respective processor 204(a), 206(1)-206(N) and a respective memory 208(a), 210(1)-210(N).

Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth. Additionally, although a single memory 210(1)-210(N) is shown for each of the respective clients 102(1)-102(N) and a single memory 208(m) is shown for each of the respective servers 202(a), a wide variety of types and combinations of memory may be employed, such as random access memory (RAM), hard disk memory, removable medium memory, and so forth.

The client 102(1) is illustrated as executing the communication module 106(1) on the processor 206(1), which is storable in memory 210(1). As previously described, the communication module 106(n), when executed, may be utilized to communicate messages in a variety of ways. For example, the messages may be communicated over the Internet 212 between the clients 102(1), 102(N) utilizing the communication service 108. In another example, the messages may be communicated directly between the clients 102(1), 102(N) utilizing a peer-to-peer network 214. A variety of other examples are also contemplated.

The communication modules 106(1)-106(N) may also be utilized to communicate a variety of different messages. For example, the messages may be configured as emails, instant messages, voicemail messages, wireless phone messages, and so on. Additionally, each of these different messages may be configured in a variety of ways. For example, as previously described the communication modules 106(1)-106(N) may be executed to provide a message communication channel 116 for communication of supplemental data which is to be utilized in the output of the message.

Message 216(1), for instance, is illustrated as including a header 218(1), a message payload 220(1) and a supplemental payload 222(1). The header 218(1), as previously described, may specify routing information for the message 216(1), a sender of the message 216(1), and so on. The message payload 220(1) includes data specified by a user of the client 102(1), such as text and attachments provided by the user to be sent to the client 102(N). The supplemental payload 222(1) includes supplemental data which may be utilized in the output of the message payload 220(1). In another instance, the message may be communicated without including a payload specified by a user of the client. For instance, message 216(N) is illustrated as including a header 218(N) and a supplemental payload 222(N) without including the message payload as described for message 216(1). Therefore, message 216(N) is formed for communication of the supplemental payload 222(N) itself.

These different message configurations may be utilized in a variety of ways. For example, message 216(1) may be utilized to take advantage of messages which are specified be sent to the client 102(N) for purposes other than communication of the supplemental payload 222(1). For instance, the user of client 102(1) may input the message payload 220(1) as a string of text, attach a picture, file, song, and so forth. The communication module 106(1) may then append the supplemental payload 222(1) to the message 216(1) for communication to the client 102(N). Thus, in this example the supplemental payload 222(1) “hitches a ride” with messages being sent to the client 102(N). Message 216(N), however, does not include a message payload and therefore is formed and communicated for the purpose of transmitting the supplemental payload 222(N) to the client 102(1). Thus, in this example, the supplemental payload 222(N) does not need to “wait” until a message is formed by a user of the client 102(N) for communication of the supplemental payload 222(N). Further, these techniques may be combined. For instance, a “timeout” feature may be utilized such that if a threshold amount of time passes, during which, a user of the client does not specify a message payload for communication to another client, the supplemental payload is sent regardless. A variety of other techniques are also contemplated for communication of messages to provide the message communication channel 116.

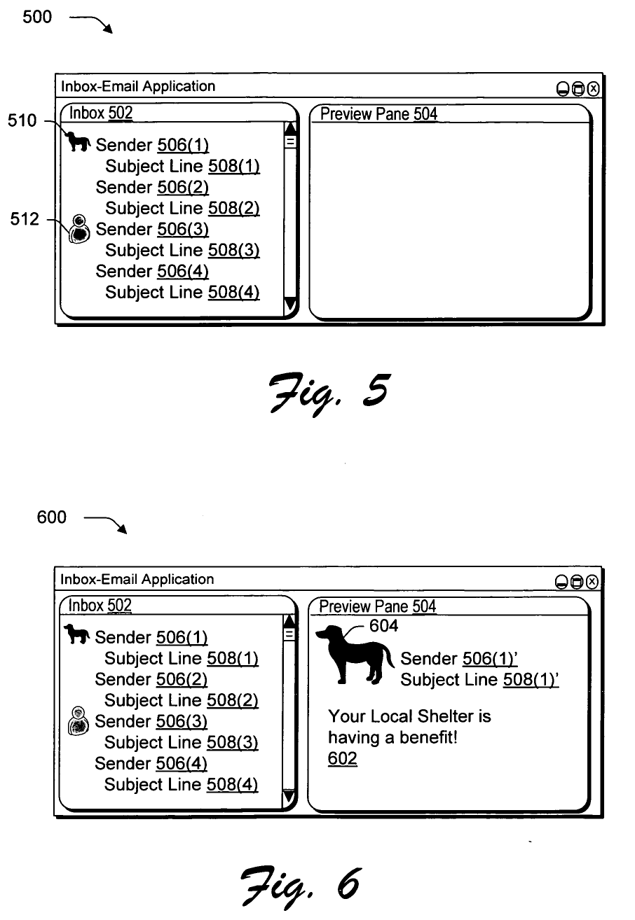

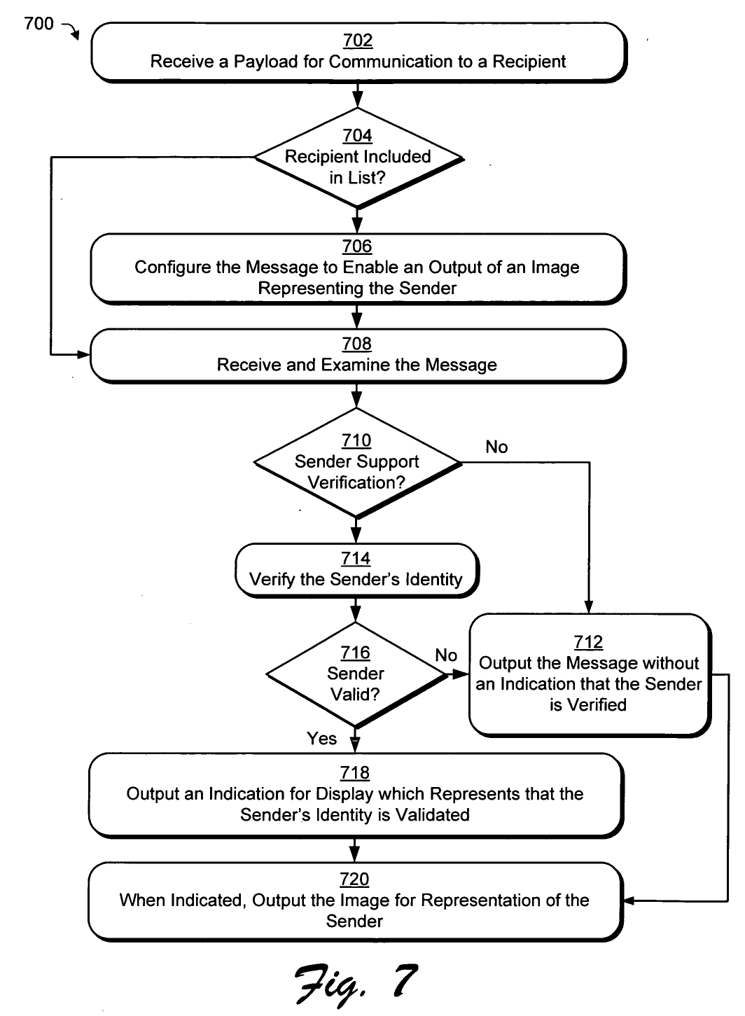

The supplemental payloads 222(1), 222(N) communicated by the respective communication modules 106(1), 106(N) may include a variety of data for communication over the message communication channel 116. For instance the supplemental payload 222(1) may include a client tile 224(1) which represents the client 102(1), such as a user of the client (e.g., a picture of the user, a favorite cartoon character, etc.), the client device itself (e.g., “Bob's Computer”), and so on. The client tile 224(1) is configured for output in conjunction with at least a portion of the message 216(1). For example, the client tile 224(1) may be output next to a “FROM:” line in an inbox of an email program, may be output when the message is selected for output, and so forth. Further discussion of client tile output may be found in relation to FIGS. 5 and 6.

The supplemental payloads 222(1), 222(N) may also include certificates 226(1), 226(N) for verifying identities of the senders of the messages 216(1), 216(N). The certificates 226(1), 226(N) may be configured in a variety of ways, such as by including a name, serial number, a public key utilized for encryption, and so on. The certificates may be privately created without a root authority, use a root authority to sign the certificate but are not provided in a directory (an example of which is the MICROSOFT PASSPORT system, MICROSOFT and PASSPORT are trademarks of the Microsoft Corporation, Redmond, Wash.), a communal system which is utilized to create the certificates (such as through use of a PGP system), and so on. Further discussion of certificates may be found in relation to FIG. 7. Although client tiles 224(1), 224(N) and certificates 226(1), 226(N) have been described as supplemental payloads 222(1), 222(N), a variety of other data may also be communicated as a supplemental payload without departing from the spirit and scope thereof.

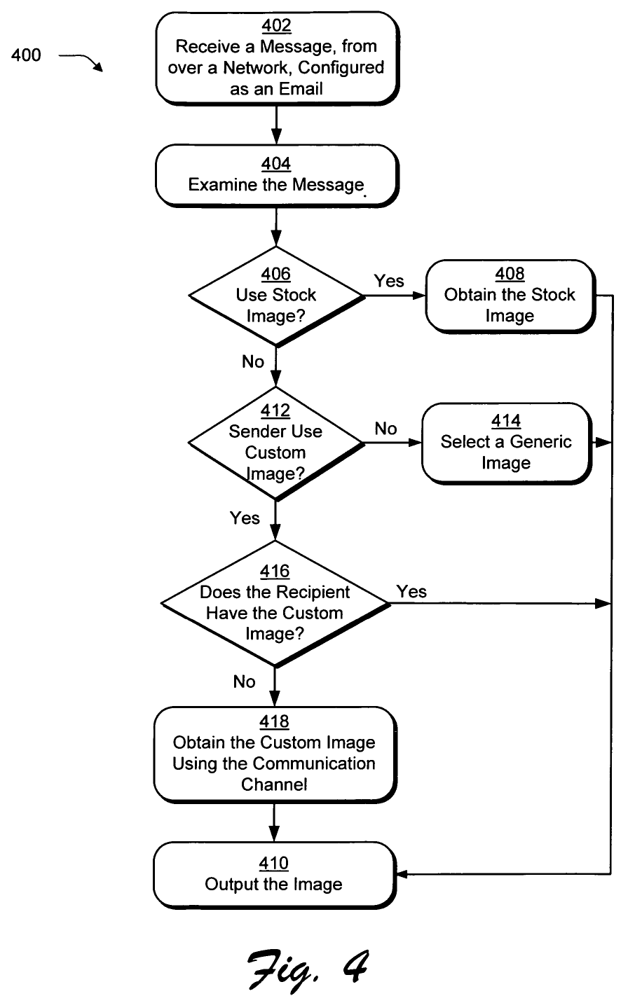

Each of the clients 102(1)-102(N) is also illustrated as included a respective one of a plurality of lists 228(1)-228(N). The lists 228(1)-228(N) may be configured in a variety of ways. For example, the lists 228(1)-228(N) may reference trusted sources (i.e., senders) of messages, such as “friends” of the respective clients 102(1)-102(N). These lists may be utilized in a variety of ways. For instance, the communication module 106(1) may be configured to send the client tile 224(1) to recipients included in the list 228(1) but not to clients which are not included in the list 228(1). In this way, communication of the client tile 224(1) may be restricted to “friends” of the client 102(1), further discussion of which may be found in relation to FIGS. 4-7.

The communication modules 106(1)-106(N) of the respective clients 102(1)-102(N) are each illustrated as including respective version 230(1)-230(N) information. The version 230(1)-230(N) is representative of an indication of the functionality supported by the respective communication modules 106(1)-106(N). For instance, communication module 106(1) may be a version of messaging software which supports animated client tiles, while communication module 106(N) may be a version of messaging software which supports static images. Therefore, the version 230(1)-230(N) may indicate to the communication modules 106(1)-106(N) which functionality is supported by other communication modules. Therefore, the communication modules 106(1)-106(N) may configure messages for communication to that other client accordingly. It should also be noted that images may be configured in a variety of ways, such as static images (e.g., a single graphic), dynamic images (e.g, video, animation), media, and so on.

Although message communication channel 116 functionality has been described as being provided by the communication modules 106(1)-106(N), the manager module 110(a) may also contribute to the functionality of the message communication channel 116. For example, the manager module 110(a) may receive a message 216(1) from client 102(1) which indicates that a client tile 224(1) is available for output in conjunction with the message 216(1). The message 216(1) may be stored in storage 232(a) by the manager module 10(a) for later retrieval by the client 102(N). The manager module 10(a), upon receipt of the message 216(1), may determine that the client 102(N) (and more particularly the communication module 106(N) of the client 102(N)) supports output of the client tile 224(1). Therefore, the manager module 110(a) may retrieve the client tile 224(1) from the client 102(1) and store the client tile 224(1) with the message 216(1) for communication to the client 102(N). Thus, the client tile 224(1) does not need to be communicated with each message, but rather is communicated to clients 102(N) which support the functionality as determined by the manager module 110(a). A variety of other examples are also contemplated in which the manager module 110(a) employs the functionality described for implementation by the communication modules 106(1)-106(N). Therefore, although the following procedures describe functions performed by the communication modules 106(1)-106(N), these functions may also be performed by the manager module 110(a).

Exemplary Procedures

The following discussion describes message communication techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the system 200 of FIG. 2.

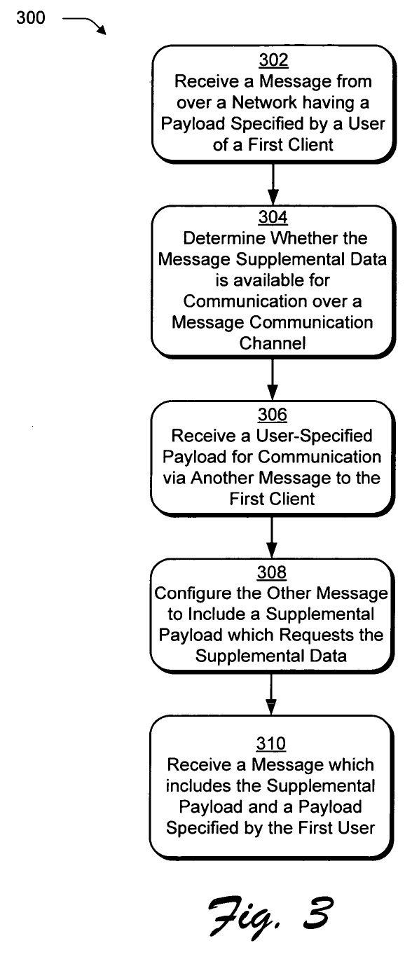

FIG. 3 is a flow diagram depicting a procedure 300 in an exemplary implementation in which messages are communicated to provide a message communication channel between clients for communication of supplemental data. A message is received from over a network having a payload specified by a user of a first client (block 302). For example, a sender of the message (i.e., the user in this instance) may input text to form a body of a message and attach one or more files for communication to an intended recipient. Thus, the text and the attachments are specified by the user.

A determination is then made as to whether supplemental data is available for communication over a message communication channel (block 304). For example, the sender of the message may support a variety of functionality which involves the use of supplemental data for output of the message and/or messages which are communicated subsequently to the message. For instance, a header of the received message may have a field which indicates that a client tile is available, that identity verification is supported via certificates, and so on. Thus, a client that receives this message and supports this functionality may determine from the header that supplemental data is available, while “legacy” clients that receive the message may ignore this field if the functionality is not supported.

A user-specified payload is received for communication via another message to the first client (block 306). For example, the communication module of the second client which received the message may wait until the user of the second client specifies a payload to be sent to the first client, such as by replying to the message. The communication module may then configure the other message to include a supplemental payload which requests the supplemental data (block 308). The second client may then receive a message which includes the supplemental payload and a payload specified by the first user (block 310). Thus, in this example the supplemental payloads are communicated with user-specified data and are thus “synchronized” with the user-specified data but are asynchronous, one to another.

As previously described, a variety of other techniques may also be utilized to communicate messages to provide the message communication channel. For example, each of the supplemental payloads may be communicated when needed such that the recipient does not need to “wait” for receipt of the supplemental data. In another example, a “timeout” threshold is utilized such that if a payload is not specified by a user for a threshold amount of time, then the supplemental payload is communicated at that time. A variety of the examples are also contemplated.

FIG. 4 is a flow diagram depicting a procedure 400 in an exemplary implementation in which an image is provided for concurrent display with a message configured as an email. A message is received, from over a network, which is configured as an email (block 402). For example, the client 102(1) may execute a communication module to generate and communicate the message 216(1) to the communication service 108. Client 102(N) may then execute a communication module 106(N) to logon to the communication service 108 and retrieve the message from the client's account.

The message is then examined (block 404). For example, the communication module 106(N) may examine fields included in the header of the email. A determination is then made from this examination as to whether a stock image is to be used (decision block 406). For example, the header may include a field “StockImage” and a value indicating whether a stock image is to be utilized in conjunction with an output of the message. If so (“yes” from decision block 406), the stock image is obtained (block 408) by the communication module 106(N). For instance, the communication module 106(N) may retrieve a stock image stored locally by an operating system of the client 102(N) and which is specified in the header for output in conjunction with the message. Therefore, the message may be output (block 410) without further communication with the sender of the message, e.g., client 102(1).

If a stock image is not to be used (“no” from decision block 406), a determination is made as to whether the sender specified use of a custom image (decision block 412). For example, another field may be utilized indicating whether or not a custom image is to be utilized. In another example, a single field may be utilized to indicate whether a stock or custom image is to be utilized based on values in the field. A variety of other examples are also contemplated.

If a custom image is not to be used (“no” from decision block 412), a generic image is selected for output in conjunction with the message (block 414), such as a generic representation of a user provided by an operating system of the client 102(N). In another implementation, at this point the client 102(N) may forgo the use of an image for that message altogether. Therefore, in such an implementation, images are output when specified by the user and are not output otherwise.

If a custom image is to be used (“yes” from decision block 412), then a determination is made as to whether the recipient has the custom image (decision block 414). For example, the client 102(N) may have previously stored an image for representing the client 102(1) in conjunction with an output of messages received from the client 102(1). Therefore, the client 102(N) (and more particularly the communication module 106(N)) may ascertain whether that image is “up-to-date”. This may be performed in a variety of ways. For instance, a hash may be taken of the image stored by the client 102(N) and compared with a hash included in the email, e.g., in the header, the supplemental payload, and so on. In another instance, image identifiers for the images are compared.

If the recipient does not have the custom image (“no” from decision block 416), then the custom image is obtained using the message communication channel (block 418). For instance, the message may be obtained using supplemental message payloads as previously described in relation to FIG. 3. Once obtained, the image is output (block 410). A variety of techniques may be utilized for output of the image, examples of which may be found in relation to the following figures.

FIG. 5 is an illustration of a user interface 500 in which an image is displayed in conjunction with a message, the image representing a sender of the message as specified by the sender. The user interface 500 depicts an email application which includes an inbox 502 pane and a preview pane 504. The inbox 502 includes a plurality of representations of emails, each of which includes a respective one of a plurality of sender 506(1)-506(4) representations and a respective one of a plurality of subject line 508(1)-508(4) representations.

In the user interface 500 of FIG. 5, two of the messages (emails in this instance) include images selected by the sender for representation of the respective sender in conjunction with an output of the message. The email which includes the sender 506(1) and subject line 508(1) representations also includes an image of a dog 510 selected by the sender of the message. The dog 510 image is displayed in the inbox 502 of the user interface 500 such that a user is focused to that message. In this instance, the dog 510 image is a custom image provided by the sender for representation of the sender. In another instance, a user selected one of a plurality of stock images for output in conjunction with the message, in this instance a standard image of a user 512. Thus, in both these instances the user's attention, when viewing the inbox 502, is drawn to messages which provide the image. It should thus be noted that the image may represent the sender without actually being an image of a sender, although images of the sender are also contemplated. This technique may be utilized in a variety of ways, further discussion of which may be found in relation to FIG. 7.

FIG. 6 is an illustration of a user interface 600 in which an image is displayed in conjunction with a message selected from the user interface 500 of FIG. 5 is displayed in conjunction with a payload of the message that was specified by the sender of the message. In the user interface 600 of FIG. 6, a payload 602 of the email is shown in a preview pane 504, which is illustrated as message text entered by the sender of the message. The email also includes header information, which includes sender 506(1)′ and a subject line 508(1)′. The image of the dog 510 of the user interface 500 of FIG. 5 is illustrated as a larger image 604 in the preview pane 504. Thus, in this instance the message text portion of the payload of the message is shown in conjunction with the image 604 specified for representation of the sender of the email whereas in FIG. 5, the image 510 was shown in conjunction with a subject line 508(1) specified by a sender of the email. A variety of other examples are also contemplated without departing from the spirit and scope thereof.

FIG. 7 is a flow diagram depicting a procedure 700 in an exemplary implementation in which an image as available to a recipient when the recipient is included in a list, the sender is also verified using the message communication channel. A payload is received for communication to a recipient (block 702). As previously described, for instance, a user may specify an email message to be communicated to an email address of an intended recipient of the message.

A determination is made as to whether the intended recipient is included in a list (decision block 704). For example, the user may have a “friends” list which references other users, to which, the user will specify supplemental data for use in output of the email message, such as a custom or stock user tile. If the recipient is included in the list (“yes” from decision block 704), the message is configured to enable an output of an image representing the sender (block 706). For instance, the email message may have a field “ClientTile” in its header set to “yes”. If the recipient is not included in the list (“no” from decision block 704) or once the message is configured (block 706), the message is communicated to the intended recipient.

The intended recipient then receives and examines the message (block 708) as previously described. From the examination, a determination is made as to whether the sender supports verification (decision block 710). For example, the email message may include another field which indicates if such functionality is supported. If not (“no” from decision block 710), the message is output without an indication that the sender is verified (block 712). If so (“yes” from decision block 710), however, the sender's identity is verified (block 714). For example, the sender and the recipient may exchange messages having certificates over the message communication channel. Based on these certificates, a determination is made as to whether the sender's identity is valid (decision block 716). If not (“no” from decision block 716), the message is output without an indication that the sender has been verified (block 712). If the sender is valid, i.e., the sender's identity is verified, (“yes” from decision block 716) an indication is output for display which represents that the sender's identity has been verified (block 718). When indicated (from block 706), the image for presentation of the sender is also output (block 720). A variety of techniques may be utilized to represent that the sender's identity has been verified, an example of which may be found in relation to the following figure.

FIG. 8 is an illustration of a user interface 800 in an exemplary implementation in which the email application of FIG. 5 is shown as including an indication that a corresponding sender of a message has been validated. The user interface includes the plurality of email messages of FIG. 5, each of which having a respective sender 506(1)-506(4) line and a respective subject line 508(1)-508(4). In the illustrated implementation, the email message having the sender and subject lines 506(1), 508(1) also includes an indication 802 (illustrated as a lock) that this message has been validated as being sent from the indicated sender. Thus, a user, when viewing the user interface 800, may readily determine that this email message has been verified by looking in the inbox 502.

Additionally, the preview pane 504 also includes an indication 804. This indication 804 is shown as a larger version of the indication 802 in the inbox 502 and also specifies that the sender's identity has been verified. A variety of other techniques and indications may also be utilized to indicate such verification without departing from the spirit and scope thereof.

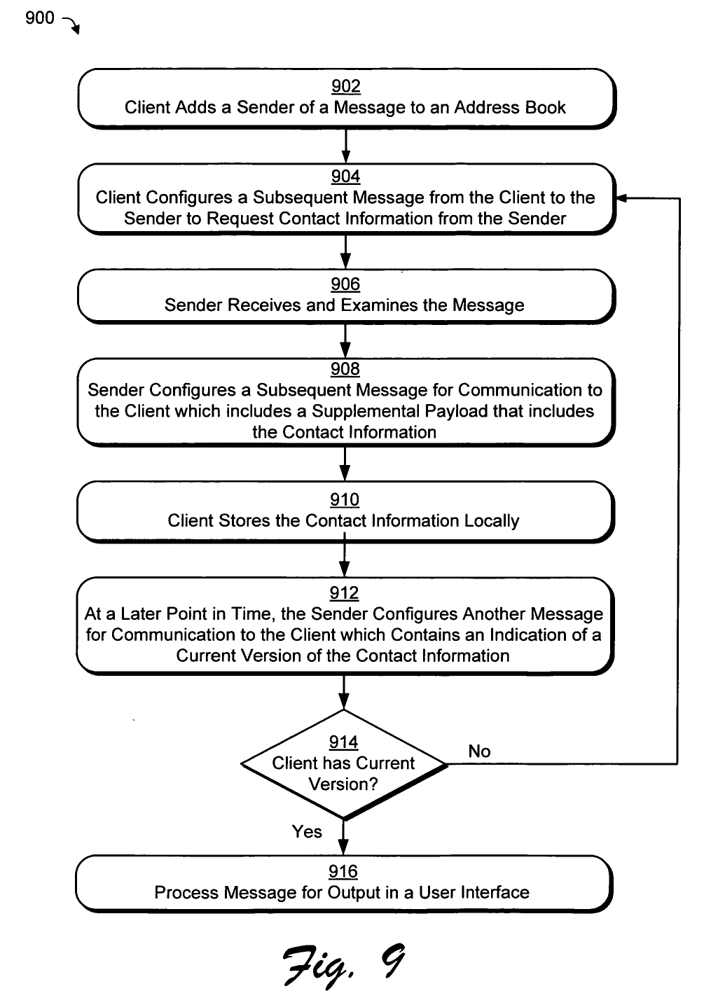

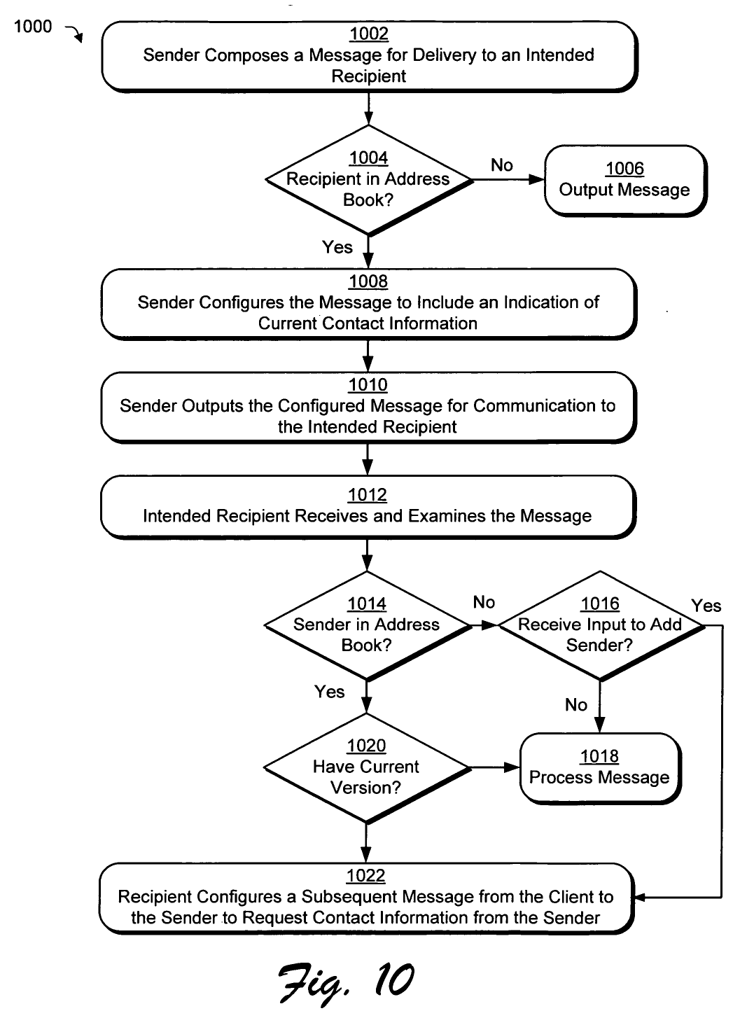

FIG. 9 is a flow diagram depicting a procedure 900 in an exemplary implementation in which communication of supplemental payload including contact information via the message communication channel of FIG. 1 is described. A client adds a sender of a message to an address book (block 902). For example, the client may have received a message from the sender and select an option in a drop-down menu for “add sender to address book”. In another example, the client may add the sender manually, by entering a network address (e.g., email address) and a “friendly” name. A variety of other examples are also plated.

The client then configures a subsequent message from the client to the sender to request contact information from the sender (block 904). For instance, the client 102(1) may receive a payload from a user, such as a text of a message and attachments. The client 102(1), through execution of the communication module 106(1), may also automatically and without user intervention add a request in a header of the message for the contact information of the sender. Thus, the message may be configured to request contact information without the user being aware of the configuration.

The sender receives and examines the message (block 906). During the examination of the message, the sender detects the request for contact information. For example, the message may include a header “Contact_Information” set to “yes”, which indicates that contact information functionality is supported and that contact information is being requested.

In response to this indication (e.g., the header), the sender configures a subsequent message for communication to the client which includes a supplemental payload that includes the contact information (block 908). For example, the supplemental payload may be queued until another message for communication to the client is detected. When detected, the supplemental payload may be added to the message for communication to the client. In an instance, a user of the sender is notified as to when the supplemental payload is to be added. In another instance, the user is not notified. A variety of other instances are also contemplated, e.g., the user may not be specifically notified (e.g., through a notification displayed in a user interface) but the size of the message may be indicative of having a supplemental payload. The message may then be communicated to the client, which is then stored locally by the client (block 910).

At a later point in time, the sender configures another message for communication to the client which includes an indication of a current version of the contact information (block 912). For example, an email header in the message may include a hash value generated from the current version of the contact information. A determination is then made as to whether the client has the current version (decision block 914) of the contact information. For instance, the client may compare the hash value in the header with a hash value computed for the contact information of the sender which is stored locally on the client. If the client has the current version (“yes” from decision block 914), the message may be processed for output in a user interface. If the client does not have the current version (“no” from decision bock 914), then a portion of the procedure 900 (e.g., blocks 904-910) may be repeated to obtain the current contact information.

FIG. 10 is a flow diagram depicting a procedure 1000 in an exemplary implementation in which presence of an intended recipient in an address book is utilized to determine whether contact information is to be provided to the intended recipient. A sender composes a message for delivery to an intended recipient (block 1002). A determination is then made as to whether the intended recipient is included in an address book (decision block 1004) of the sender. By inclusion in the address book, this determination may indicate whether the intended recipient is “trusted”. Although an address book has been described in this example, a variety of listings of users, with which, the client has had and/or is willing to have contact may be utilized without departing from the spirit and scope thereof.

When the intended recipient is not in the address book (“no” from decision block 1004), the message is output for communication to the intended recipient (block 1006). When the intended recipient is included in the address book (“yes” from decision block 1004), the sender configures the message to include an indication of current contact information (block 1008). For example, the message may include a unique identifier of the contact information, a value generated using the contact information itself (e.g., a hash value), and so on. The sender then outputs the configured message for communication to the intended recipient (block 1010).

The intended recipient receives and examines the message (block 1012). Based on the examination, a determination is made as to whether the sender is included in an address book of the recipient (decision block 1014). If not (“no” from decision block 1014), a determination is then made as to whether an input has been received to add the sender to the address book (decision block 1016). If such an input has not been received (“no” from decision block 1016), the message is processed (block 1018) without adding the sender to the address book. Thus, in this example, the sender is not added to the address book and/or the contact information updated without approval from the recipient, either implied (e.g., already in the address book) or expressed (e.g., the input to add the sender).

When the intended recipient is included in the address book (“yes” from decision block 1014), a determination is made as to whether the recipient has the current version of the contact information (decision block 1020). For example, unique identifiers, hash values, and so on, may be compared to determine if the version stored locally by the recipient is the most “up-to-date version” of the contact information. When the recipient has the current version (“yes” from decision block 1020), the message is processed for output (block 1018) in a user interface.

When the intended recipient does not have the current version (“no” from decision block 1020) or an input has been received to add the sender to the address book (“yes” from decision block 1016), the recipient configures a subsequent message from the recipient to the sender to request contact information from the sender (block 1022). For example, the recipient may receive a payload as previously described and append a supplemental payload which includes the contact information as previously described. Although in this embodiment, the communication of contact information has been described, a wide variety of supplemental payloads may be communicated and updated utilizing the previously described techniques.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
determining whether an intended recipient of a message is included in a list; and
when the intended recipient is included, configuring the message to indicate that a particular image which represents a sender of the message is specified for output in conjunction with messages from the sender by the intended recipient.

2. A method as described in claim 1, wherein the message is an email, a voicemail, a mobile text message, or an instant message.

3. A method as described in claim 1, wherein the list is formed by the sender and references a plurality of clients permitted to receive the image.

4. A method as described in claim 1, wherein the configuring includes indicating a version of software that supports output of the particular image.

5. A method as described in claim 1, further comprising communicating the message without performing the configuring when the intended recipient is not included in the list.

6. A method as described in claim 1, wherein the determining and the configuring are performed by the sender of the message and further comprising ascertaining whether the intended recipient has already stored the particular image locally.

7. A method as described in claim 6, wherein the ascertaining further includes ascertaining whether a locally stored image is an up-to-date version of the particular image.

8. A method as described in claim 6, further comprising configuring another message for communication to the sender indicating that the recipient does not have a locally stored copy of the particular image.

9. A method as described in claim 8, wherein the other message is configured upon receipt of a payload specified for communication to the sender by a user of the recipient.

10. A method comprising:
determining from a message received over a network by a recipient from a sender whether the sender is configured to provide contact information of the sender; and
upon receipt of a payload specified for communication to the sender from a user of the recipient, forming another message which includes the payload and a request for the contact information.

11. A method as described in claim 10, wherein the determining includes ascertaining whether the recipient has a current version of the contact information, and if not, performing the forming of the other message.

12. A method as described in claim 11, wherein the ascertaining includes comparing a hash value included in the message with a hash value of a version of contact information stored by the recipient.

13. A method as described in claim 10, wherein the message is an email, a mobile text message, a voicemail or an instant message.

14. A method as described in claim 10, wherein the determining is performed by examining a header of the message.

15. A method as described in claim 10, wherein the forming is performed without notifying the user of the recipient.

16. One or more computer readable media comprising computer executable instructions that, when executed on a computer, direct the computer to communicate with another computer via a network utilizing a plurality of email messages, wherein:
at least one said email message includes a payload specified by a user and includes an indication that supplemental data is available for output of messages from the computer by the other computer; and
another said email message, communicated subsequent to communication of the at least one said email message, includes the supplemental data.

17. One or more computer readable media as described in claim 16, wherein the supplemental data is an image for representing of a user of the computer on the other computer in conjunction with one or more said email messages.

18. One or more computer readable media as described in claim 16, wherein the indication is included in a header of the at least one said email message.

19. One or more computer readable media as described in claim 16, wherein the supplemental data is contact information.

20. One or more computer readable media as described in claim 16, wherein the supplemental data is a certificate for verifying an identity of a user of the computer.
